(19) United States
(12) Patent Application Publication
(10) Pub. No.: US 2004/0125862 A1
(43) Pub. Date: Jul. 1, 2004

(54) Pilot processing architecture

(76) Inventors: Tao Li, San Diego, CA (US); Chandra Ramabhadra Murthy, La Jolla, CA (US)

Correspondence Address: Qualcomm Incorporated, Patents Department, 5775 Morehouse Drive, San Diego, CA, 92121-1714, US

(21) Appl. No.: 10/286,043

(22) Filed: Oct. 31, 2002

(51) Int. Cl. H04B 1/707

(52) U.S. Cl. 375/147

(57) ABSTRACT

A pilot signal processor is used to handle the Pilot Channel related processing. This is accomplished using dedicated hardware processing instead of with firmware in a DSP processor at the demodulation front end. Typically the DSP processor is much less power efficient than dedicated hardware, so by moving some tasks out of the firmware into dedicated hardware engine, the MIP requirement of the DSP processor and the overall power consumption will reduce. Further, moving these functions to a hardware processor results in improved system performance due to the reduced processing latency (hardware-hardware-hardware vs. hardware-firmware-hardware). The functions of the pilot signal processor include a pilot filter, odd pilot processing, RSSI lock detection, Nt_Io estimation, frequency tracking loop, and time tracking loop.

### TECHNICAL FIELD

The present application relates to pilot signal related processing, and more particularly to providing an integrated hardware implementation of the pilot signal processing.

### BACKGROUND

The use of code division multiple access (CDMA) modulation techniques is one of several techniques for facilitating communications wherein a large number of system users are present. Other multiple access communication system techniques, such as time division multiple access (TDMA), frequency division multiple access (FDMA) and AM modulation schemes such as amplitude companded single sideband (ACSSB) are known in the art. Techniques for distinguishing different concurrently-transmitted signals in multiple access communication systems are also known as channelization. The spread spectrum modulation technique of CDMA has significant advantages over other multiple access techniques.

Wireless communications systems such as CDMA typically operate using a variety of channels. In CDMA, for example, channelization is accomplished using orthogonal or quasi-orthogonal codes. Different channels generally have different purposes. Common channels are used to communicate to a plurality of mobile stations or base stations at the same time while dedicated channels are typically used for communication to and from one mobile station.

Pilot channels are channels that are receivable by a plurality of mobile stations for use in pilot set maintenance (selection of serving sector(s)) and coherent demodulation. tracking loop, and time tracking loop.

These and other features and advantages of the embodiments will become more apparent upon reading the following detailed description and upon reference to the accompanying drawings.

### DESCRIPTION OF DRAWINGS

FIG. 1 illustrates the top level architecture of a Common Pilot Processor.

FIG. 2 shows one embodiment of the ADD_SUB block used in the Common Pilot Processor of FIG. 1.

FIG. 3 shows one embodiment of the MAC block used in the Common Pilot Processor of FIG. 1.

FIG. 4 shows one embodiment of the IIR filter used in the Common Pilot Processor of FIG. 1.

FIG. 5 shows one embodiment of the IIR filter of FIG. 4.

FIG. 6 shows the block diagram of the hardware implementations of the Common Pilot Processor.

FIG. 7 shows the block diagram of the pilot filter architecture.

FIG. 8 shows a block diagram of the Odd Pilot Processing architecture.

FIG. 9 is a diagram of the architecture of the Nt_lo estimation block.

FIG. 10 is a diagram of the architecture of the RSSI lock detection block.

FIG. 11 is a block diagram of the frequency tracking loop.

FIG. 12 illustrates the architecture of the frequency tracking loop in acquisition mode.

FIG. 13 illustrates the architecture of the frequency tracking loop in tracking mode.

FIG. 14 presents a visual representation of the early and late energies for three offset cases of finger timing.

FIG. 15 is a block diagram of the time tracking loop.

### DETAILED DESCRIPTION

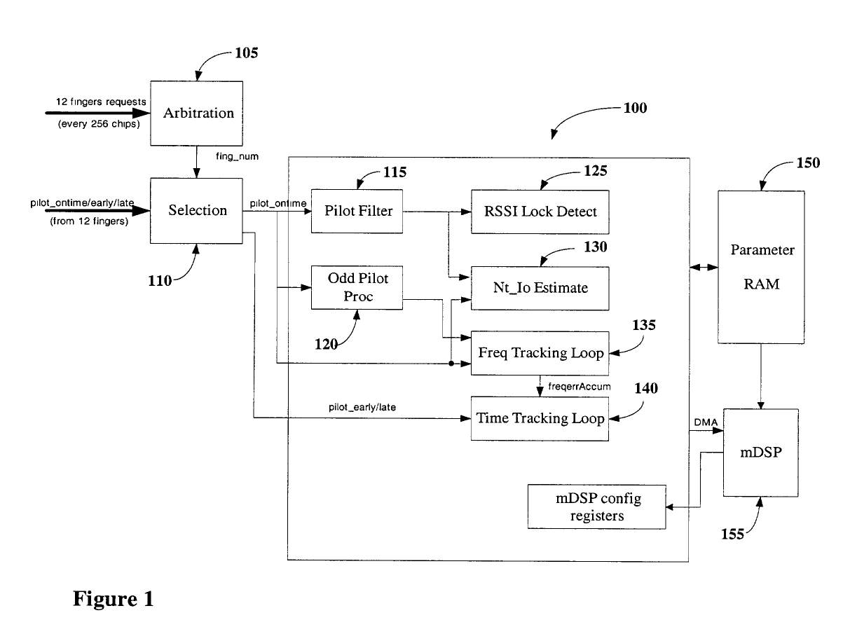

FIG. 1 shows the top level architecture of the Common Pilot Processor 100. The processing hardware is shared by all fingers, and the operations of the fingers are time-multiplexed. An arbitration block 105 at the front end decides which finger will be processed in the next 20 chipx1 clock cycles. Since the pilot processing rate is 256 chips, and there are 12 fingers, as long as the processing time per finger is less than 256/12=21 chipx1 clock cycles, the Common Pilot Processor can handle the requests from all the fingers in time. It does not matter how to arrange the priority order among the fingers, so the priority is chosen as follows:

finger0>finger1>finger2 >. . . >finger11

The descrambled ontime, early, and late pilot data from each finger is selected by the fing_num signal generated from the arbitration block 105 in a selection block 110, and feed into a Pilot Filter block 115, an Odd Pilot Processing 120 blocks, and the Time Tracking Loop block 140. The outputs of the Pilot Filter 115 and the Odd Pilot Processing 120 clocks are used by an RSSI Lock Detect block 125, an Nt_Io Estimate block 130, and a Frequency Tracking Loop block 135 for further processing. The Common Pilot Processor 100 zprocessing results are DMA to MEMC of the DSP processor 155 through micro DMA ch0. The Parameter RAM 150 stores the intermediate results of the Common Pilot Processor 100 for each of the 12 fingers. To save power, the Common Pilot Processor 100 may run at chipx1 clock instead of chipx8 clock.

The Common Pilot Processor 100 performs intensive data computations. To save area, some hardware components may be shared by different blocks, and used for multiple functions at different pipeline stages. There are three such components in the CPP (Common Pilot Processor) 100:

ADD_SUB (adder and subtractor)

MAC (Multiple and Accumulation)

IIR filter

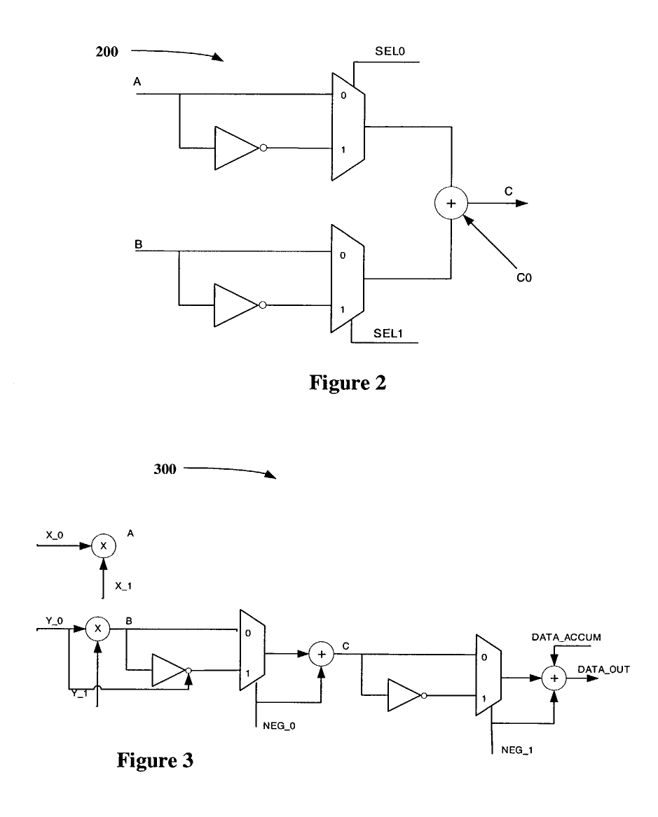

FIG. 2 shows one embodiment of the ADD_SUB block used in the Common Pilot Processor 100 of FIG. 1. As indicated by the name, the ADD_SUB block 200 is used for adding or subtracting between the two input data.

If SEL0=‘0’, SEL1=‘0’, and C0=‘0’, then C=A+B

If SEL0=‘0’, SEL1=‘1’, and C0=‘1’, then C=A−B

If SEL0=‘1’, SEL1=‘0’, and C0=‘1’, then C=B−A

The ADD_SUB block 200 may be used for the Pilot Filter 115, Odd Pilot Processing 120, and Nt_Io Estimation 130.

FIG. 3 shows one embodiment of the MAC block 300 used in the Common Pilot Processor 100 of FIG. 1. The MAC block 300 does multiplying and accumulation, and can be used to calculate energy (amplitude square) and cross product (CP).

|x|²=Re(x)*Re(x)+Im(x)*Im(y)

CP(x,y)=Re(x)*Im(y)−Im(x)*Re(y)

The MAC block takes one clock cycles to calculate |x|²+|y|², or CP. The MAC block may be used for Nt_Io Estimation 130, RSSI Lock Detect 125, Frequency Tracking Loop 135, and Time Tracking Loop 140.

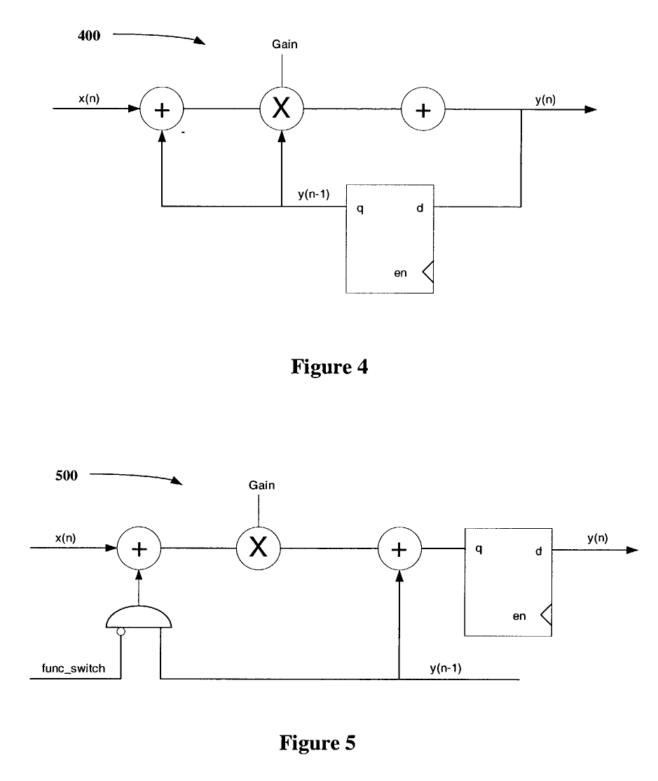

FIG. 4 shows one embodiment of the first order IIR filter 400 used in the Common Pilot Processor 100 of FIG. 1, where y(n)=Gain*x(n)+(1-Gain)*y(n−1). The same form of IIR filter 400 (with different gain factors) is used as the low pass filter for Pilot Filter 115, Nt_Io Estimation 130, and RSSI Lock Detect 125. The same hardware implementation can also be configured for the filter gain multiplication and accumulation stage of the Frequency Tracking Loop 135 and Time Tracking Loop 140 with the first adder bypassed.

FIG. 5 shows the implementation 500 of one embodiment of the IIR filter of FIG. 4. When func_switch=‘1’, the filter function becomes y(n)=Gain*x(n)+y(n−1), which is used by the Time tracking loop 140 and Frequency tracking loop 135.

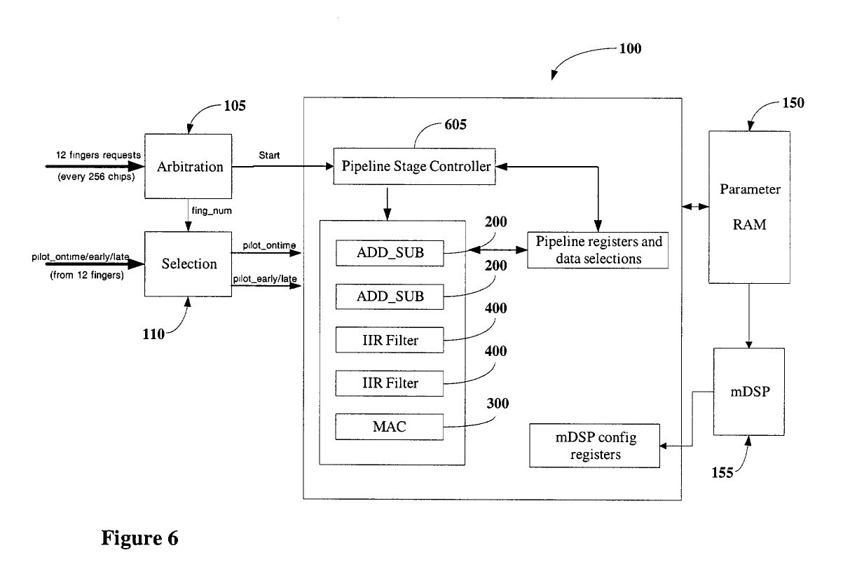

FIG. 6 shows a block diagram 600 of the hardware implementations of the Common Pilot Processor 100. The ADD_SUB 200, MAC 300, and IIR filters 400 are used for different functions at different pipeline stage. The details of how to use these components, select data, and read/write the Parameter RAM for different functions will be discussed below.

The Pipeline Stage Controller 605 shown in FIG. 6 is triggered by the Arbitration block 105, and can control the Common Pilot Processor 100 finishing all functions in 12 chipx1 clock cycles.

The pipeline stages will be driven by chipx1 clock generated from choosing one chipx8 clock out of 8 chipx8 clock cycles. The Parameter RAM access (HW read/write, and DSP processor read) interleaves with the pipeline stage clock within 8 chipx8 cycles.

The pilot filter 115 provides a estimation of the channel fading coefficients (complex phase reference), that can be used in the demodulation process to undo the phase distortion introduced by the channel. The pilot estimate is created by passing the pilot symbols (despeaded in 256 chips) through a low-pass filter (used to be a first order IIR), that effectively acts as an averaging or smoothing filter. The pilot filter is per finger operation.

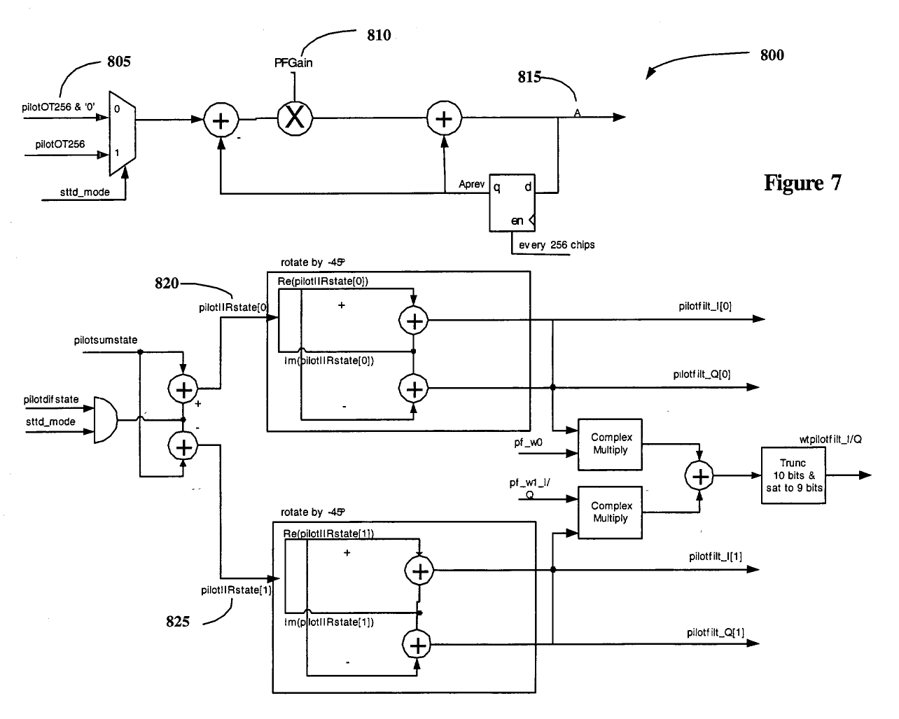

The pilot filter 115 may be designed to improve the system performance in high speed/fast fading conditions. Instead of operating at every 512 chips due to STTD mode, the pilot filter 115 may now update at every 256 chips. FIG. 7 shows the block diagram 800 of the new designed pilot filter.

The pilot symbol (pilotOT256) 805 is fed into the pilot filter 115 in every 256 chips. The filter gain (PFgain) 810 and the meaning of A 815 change depending on the pn_cnt_256_chips value, that increases by one every 256 chips. Choices of PFgain 810 and A 815 are given in Table 1. In the transmit diversity mode (STTD or closed loop mode), the CPICHs from Antenna 0 and Antenna 1 follow different patterns as shown in Table 2. So when pn_cnt_{—}256_chips=4n or 4n+3, the received pilot symbol is the sum of the pilot symbols from both antennas; when pn_cnt_{—}256_chips=4n+1 or 4n+2, the received pilot symbol is the pilot symbol from Antenna 0 minus the pilot symbol from Antenna 1, where, n=0,1,2, . . . , 37, and pn_cnt_{—}256_chips =0,1,2, . . . , 149. PilotIIRstate[0] 820 is the pilot filter output for the pilot estimation from Antenna 0, and PilotIIRstate[1] 825 is the pilot filter output for the pilot estimation from Antenna 1 if in STTD or closed loop transmit diversity mode.

TABLE 1
Choices of A and PFGain

| PN_CNT_256_Chi | | |
|---|---|---|
| ps | | |
| (0, 1, 2, . . . , 149) | A | PFGain |
| 0 | pilotsumstate | g³ |
| 1 | pilotdifstate | g³ |
| 4n (n! = 0) | pilotsumstate | g² |
| 4n + 1 (n! = 0) | pilotdifstate | g¹ |
| 4n + 2 | pilotdifstate | g² |
| 4n + 3 | pilotsumstate | g¹ |

Note: g1, g2, g3 are different gains, and the selection among them depends on pn_cnt_{—}256_value. In non TD mode, only g1 is used as the pilot filter gain.

TABLE 2
Pilot Filter Processing

| | ANT 0 | ANT 1 | | IIR Filter to | |
|---|---|---|---|---|---|
| pn_cnt_256_chips | Pattern | Pattern | Type | Update (A) | PFGain |
| 147 | A | A | 4n + 3 | SUM | g1 |
| 148 | A | A | 4n | SUM | g2 |
| 149 | A | −A | 4n + 1 | DIFF | g1 |
| 0 | A | A | 0 | SUM | g3 |
| 1 | A | −A | 1 | DIFF | g3 |
| 2 | A | −A | 4n + 2 | DIFF | g2 |
| 3 | A | A | 4n + 3 | SUM | g1 |
| 4 | A | A | 4n | SUM | g2 |
| 5 | A | −A | 4n + 1 | DIFF | g1 |
| 6 | A | −A | 4n + 2 | DIFF | g2 |
| 7 | A | A | 4n + 3 | SUM | g1 |
| 8 | A | A | 4n | SUM | g2 |
| 9 | A | −A | 4n + 1 | DIFF | g1 |

In the non transmit diversity mode, the base station only transmits data from Antenna 0, so the pilotIIRstate[1] 825 is not needed and the pilot filter output for Antenna 1 (pilotfiltI/Q[1]) will be set to 0. DDE/DDE1 uses the pilotfiltI/Q[0] to do the dot/cross operations with the despreaded data symbols.

In the STTD mode, the base station transmits data from both Antenna 0 and Antenna 1, so the pilot filter outputs for both Antenna 0 and Antenna 1 (pilotfilI/Q[0] and pilotfiltI/Q[0] will be used by the DDE/DDE1 to do the dot/cross operations with the despreaded data symbols.

In the closed loop transmit diversity mode, the base station transmits DPCH and the associated PDSCH from both Antenna 0 and Antenna 1. The Channel coding, interleaving and spreading are done as in non-diversity mode. The spread complex valued signal is fed to both TX antenna branches, and weighted with antenna specific weight factors w1 and w2. The weight factors are complex valued signals (i.e. wᵢ=a₁+jbᵢ), in general.

For the closed loop mode 1 different (orthogonal) dedicated pilots symbols in the DPCCH are sent in the two different antennas. For closed loop mode 2 the same dedicated pilot symbols in the DPCCH are sent on both antennas.

The CPICH0 and CPICH1 transmitted from the two antennas follows the same patterns as the STTD mode. So the pilot filter still needs to process pilot symbols for both antennas as in STTD mode. The difference is that DDE/DDE1 will either use the pilot filter outputs (pilotfilt_I/Q[0] and pilotfilt_I/Q[1]) directly, or use the weighted pilot filter outputs (pilotfilt[0]*w₁+pilotfilt[1]*w₂) , to do the dot/cross operations. Since the DPCH and the associated PDSCH are not coded as the STTD mode (except the dedicated pilots in closed loop mode 1), the pilot symbols of Antenna 1 should be set to 0 for CLTD mode.

One new issue comes out because of the closed loop transmit diversity mode. The weight factors only apply on the DPCH( except the dedicated pilots in closed loop mode 1) and the associated PDSCH, not the common channels, so in this mode different pilot symbols are used for different physical channels to do the dot/cross operations, i.e., use the pilot filter output (pilotfiltI/Q[0]) for common channels (like PCCPCH, etc.), and use the weighted pilot symbols (wtpilotfilt_I/Q) for DPDCH, DPCCH, and the associated PDSCH.

During a compressed mode gap the state variable are frozen (skip operation.) At the end of the compressed mode gap, the state (pilotIIRState, pilotSumState and pilotDifState) is kept as-is or reset to 0 depending on a flag (flag shared between all fingers).

When the combining lock of an active finger is ‘0’ (generated by the RSSI lock detection block), that means out of lock, the pilot filter's outputs used for dot/cross operation of this finger are forced to be ‘0’. So no combining happens on this finger's data symbols.

According to the standard, the common pilot signal can be transmitted by one or two antennas in order to achieve transmit diversity. The pilot symbol sequences sent by the two antennas are shown in Table 3, where A equals to the constant complex symbol 1+j.

TABLE 3
Pilot Patterns of Two Antennas

| pn_cnt_256_chips | 0 | 1 | 2 | 3 | 4 | 5 | 6 | 7 |
|---|---|---|---|---|---|---|---|---|
| Antenna 0 | A | A | A | A | A | A | A | A |
| Antenna 1 | A | −A | −A | A | A | −A | −A | A |

Since both transmissions travel through the same channel, the pilot symbol sequence received is the sum of the two sequences transmitted as shown in Table 4.

TABLE 6
Received Pilot Symbols from Two Antennas

| pn_cnt_{—} | | | | | |
|---|---|---|---|---|---|
| 256_chips | 0 | 1 | 2 | 3 | 4 |
| Antenna 0 | A0 | A0 | A0 | A0 | A0 |
| Antenna 1 | A1 | −A1 | −A1 | A1 | A1 |
| Received | A0 + A1 | A0 − A1 | A0 − A1 | A0 + A1 | A0 + A1 |
| Symbol | | | | | |

The task of the Odd Pilot Processing block 120 is to separate the received pilot sequences from the two antennas. From Table 3 and Table 4, it can be observed that at odd 256-chip numbers, the current accumulated pilot symbol (pilotOT256) and the accumulated pilot symbol in previous 256 chips(pilotOT256Prev) are either the sum of A0 and A1 or the difference of A0 and A1.

There are two cases when the 256-chip number is odd:

Case 1: the 256-chip number is 4n+1, like 1,5,9, so forth, where n=0,1, . . . ,37

In this case, pilotOT256=A0-A1, and pilotOT256Prev =A0+A1, so pilotOT512[0]=pilotOT256+pilotOT256Prev=2*A0, and pilotOT512[1]=pilotOT256Prev−pilotOT256=2*A1, where pilotOT512[0] is the 512 chips accumulation of Antenna 0's pilot signal, and pilotOT512[1] is the 512 chips accumulation of Antenna 0's pilot signal.

Case 2: the 256-chip number is 4n+3, like 3,7,11, so forth, where n=0,1, . . . ,37

In this case, pilotOT256 =A0+A1, and pilotOT256Prev=A0−A1, so pilotOT512[0]=pilotOT256+pilotOT256Prev=2*A0, and pilotOT512[1]=−(pilotOT256Prev−pilotOT256)=2*A1, where pilotOT512[0] is the 512 chips accumulation of Antenna 0's pilot signal, and pilotOT512[1] is the 512 chips accumulation of Antenna 0's pilot signal. In non transmit diversity mode, the pilotOT512[1]=0.

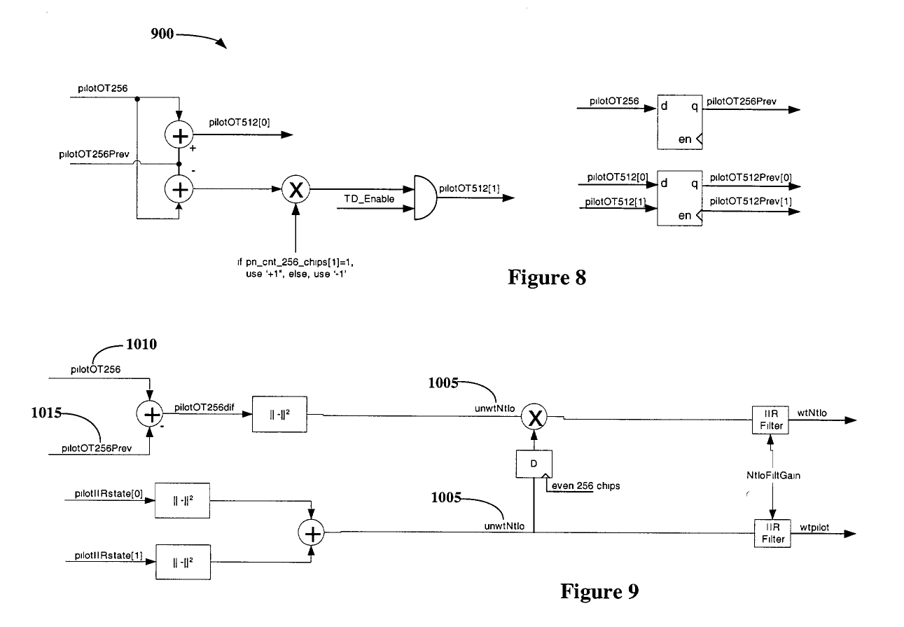

FIG. 8 shows the block diagram 900 of the Odd Pilot Processing block. The output of this block will be used by the Frequency Tracking Loop block 135. The TD_Enable signal equals ‘1’ when in STTD or the closed loop transmit diversity mode.

In the compressed mode, the Odd Pilot Processing block 120 is idle, and the pilotOT256Prev and pilotOT512Prev are reset to ‘0’ during the transmission gap.

The Nt_Io estimation block 130 uses pilot symbols from the CPICH to compute the energy of the interference and of the pilot. As shown in FIG. 9, the noise energy (unwtNtIo) 1005 is estimated by calculating the energy of the difference between the current pilot symbol(pilotOT256) 1010 and the previous pilot symbol(pilotOT256Prev) 1015 at even finger processing periods (pn_cnt_256_chips is even number, but not zero, per frame). The difference between successive pilot symbols is attributable to the noise because the two consecutive common pilot samples at even 256-chip periods (except zero) have the same value in the absence of frequency error (refer to Table 3); and the frequency error should become negligible by the time of combiner lock. The noise power estimate (unwtNtIo) 1005 is weighted by the total energy of the current pilot symbol (totalPilotenergy) under the principle that more confidence is given to estimates derived from strong pilot signals than to estimates derived from weak pilot signals.

The pilot-weighted Nt_Io measurement is passed through a low pass IIR filter because the intention is to measure the noise energy of the past a few 512-chip period in some average sense. From the weighted Nt/Io estimate, an additional corresponding pilot energy estimate is needed to compute the Nt-to-pilot ratio estimate. The total pilot energy estimate of both antennas is also implemented in the Nt_Io estimation block 130, that uses the pilot filter outputs.

The Nt_Io Estimation block 130 may operate under different conditions. The pilotIIRstate[1] is set to ‘0’s when in non transmit diversity mode. During a compressed mode gap, the state variables are frozen (skip operation.). At the end of the compressed mode gap, the state is kept as-is or reset to 0 depending on a flag (flag shared between all fingers.) Also at the end of the compressed mode gap, the pilotOT256 prev will be out of date. Thus, it makes sense to ignore the first 256-chip boundary following the gap to update the filter and running the Nt_Io estimation starting from the following even 256-chip boundary after the gap. The Nt_Io Estimation is only executed for the active finger when the finger is in combiner lock. If the finger is not in combiner lock, the Nt_Io Estimation is skipped. The combiner lock status is obtained from the RSSI lock detection block.

The RSSI Lock Detect block 125 computes the energy of the pilot symbols (pilotlIRstate[0]/[1]) for both antennas, and low pass filters the energy values to produce the Received Signal Strength Indication (RSSI). The low pass filter is of the form: y(n)=g*x(n)+(1−g)*y(n−1). The RSSIs from the two antennas are summed to produce the totalRSSI. Depending on the totalRSSI and the commands from DSP processor 155, the finger may be put into lock for time tracking, data symbol combining, or power symbol control combining.

The RSSI lock detection algorithm is specified as following:

RSSI lock control (per finger, programmed by the ARM, possibly through the DSP processor) consists of the following fields:

set lock

reset lock

TT enable

combiner lock enable

power lock enable

Using the above five parameters, and using the totalRSSI value and the previous lock detect state, the RSSI lock status is determined. The RSSI lock status (per finger) consists of the following parameters:

lock detect state

TT lock status

combiner lock status

power lock status

The logic for this is as follows:

if (set lock == 1)

lock detect state = “true”
TT lock status = TT enable
combiner lock status = combiner lock enable

if (totalRSSI > power lock threshold)

power lock status = power lock enable

else

power lock status = “false”

end
else if ((reset lock == 1) OR (totalRSSI < lower lock threshold))

lock detect state = “false”
TT lock status = “false”
combiner lock status = “false”
power lock status = “false”

else if ((lock detect state previous == true) OR (totalRSSI > upper
lock threshold))
lock detect state = “true”
TT lock status = TT enable
combiner lock status = combiner lock enable
if (totalRSSI > power lock threshold)

power lock status = power lock enable

else

power lock status = “false”

end
end

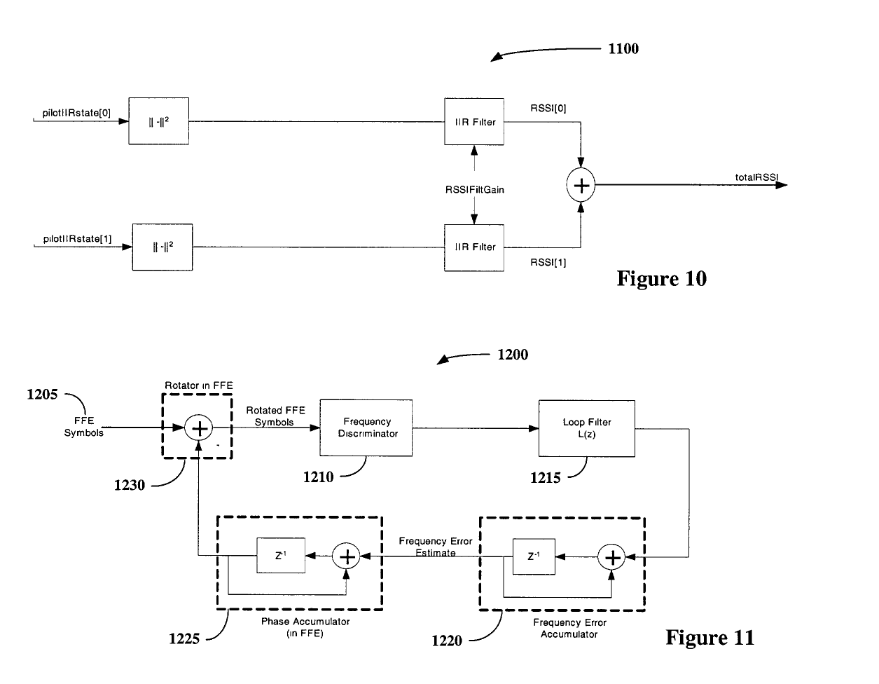

FIG. 10 shows the architecture 1100 of the RSSI lock detection block. The microprocessor needs to know RSSI[0] and RSSI[1] separately, and the gain factor of the IIR filter is RSSIFiltGain that is different from the NtIoFiltGain used by-the IIR filter of the pilotenergy. So the totalRSSI is different from the wtpilot computed in the Nt_Io estimation block. The hardware used to generate the RSSI and Nt_Io is not shared except the ∥pilotIIRstate[0]∥² and ∥ pilotIIRstate[0]∥² parts.

During a compressed mode gap, the state variables are frozen (skip operation.) At the end of the compressed mode gap, the state is kept as-is or reset to 0 depending on a flag (flag shared between all fingers.). The DSP processor registers are as follows:

write registers:

RSSI lock control—per finger

RSSI filter gain—common to all fingers

Power lock threshold, lower lock threshold, upper lock threshold—common to all fingers

cmRSSILockDetectReturnValueFlag: 1 bit, common to all fingers. If set—then at the end of (or when entering—use any convenient time) compressed mode, clear the state variables (rssi0 and rssi1)

read registers:

RSSI lock status, comprising the following: lock detect, tt-lock, comb-lock, and power-lock states.

rssi[antenna 0] and rssi[antenna 1]

totalRSSI (DSP can derive it by adding rssi[antenna 0] and rssi[antenna 1]. So this data may not be returned to the DSP processor, depending on the DMA load)

The frequency tracking loop (FTL) 135 tracks the common pilot received from the base station, and corrects each finger's frequency error (change in pilot phase per unit time) by determining the frequency error and sending the error to the phase rotator in the FFE. One source of frequency error is doppler shift caused by the mobile's movement with respect to the base station's antenna(s). In addition to frequency doppler, the basestation's and mobile's oscillators also introduce additional frequency error due to the oscillators'inherent frequency variations.

FIG. 11 contains a functional diagram 1200 of the frequency tracking loop. The frequency tracking loops receives complex pilot symbols 1205 from the FFE, that are rotated based on the previous frequency error estimate, and generates a new frequency error estimate. The frequency discriminator 1210 computes the cross product between successive pilot symbols in 256 or 512 chips as shown in Equation 1.

Metric_{frequency}=(Iₙ₋₁ ×Qₙ)−(Iₙ₋ᵢ×Qₙ₋1) Equation 1

The goal of the frequency discriminator 1210 is to produce a response that is linear to the frequency difference in the two pilot symbols. The FTL 135 passes the output of the frequency discriminator 1210 through a 0th-order loop filter 1215, that is simply a constant multiplication, to control the time constant of the loop. Finally, the frequency error is integrated via an accumulator 1220 to form the current frequency error estimate. FIG. 13 also shows a phase accumulator 1225 and rotator 1230 to complete the FTL, although both are implemented in the FFE.

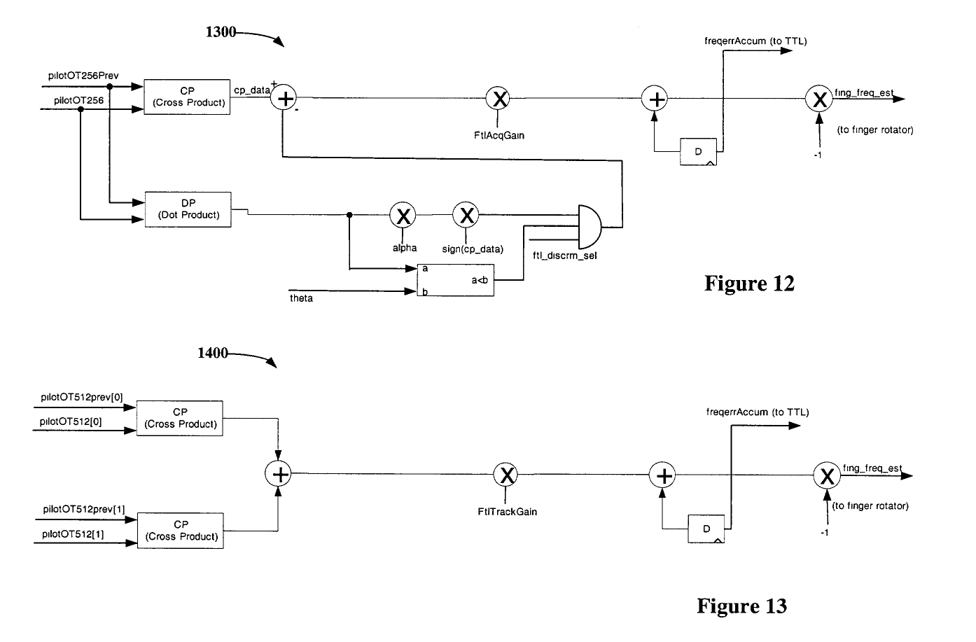

There are two mode operations for the FTL 135: Acquisition Mode and Tracking Mode. The purpose of the Acquisition Mode is to quickly track the frequency from the error of 5k Hz to within 1k Hz. FIG. 12 shows the architecture 1300 of the FTL in Acquisition mode.

In the Acquisition Mode, the cross-product between pilot symbol 2n and pilot symbol 2n-1 is calculated on the nth even finger block processing period (pn_cnt_{—}256_chips is even number, but not zero), when n=1,2,3, . . . This is because the two pilot symbols used for phase comparison in two consecutive 256-chip periods should be the same at the transmission side, and according to the standard, this is true on every even pilot symbol period except the first one in the pilot sequence per frame.

The algorithm of the frequency discriminator is shown below,

cp = CP(pilotot256_prev, pilotot256) (cross product)
dp = DP(pilotot256_prev, pilotot256) (dot product)
delta_freq^{new} = cp,
if (dp < theta)

if(cp>=0)

delta_freq^{new} = delta_freq^{new} − alpha*dp

else

delta_freq^{new} = delta_freq^{new} + alpha*dp

end

end

Where theta and alpha are constants whose values are design parameters. alpha can be programmed as 0, 1, 2, or 4. If ftl_discrm_sel=‘1’, the frequency discriminator is selected as the frequency discriminator of the FTL in ACQ mode.

The Tracking Mode is slower, has a smaller pull-in range and tacks the frequency within 200 Hz. FIG. 13 shows the architecture 1400 of the FTL in Tracking Mode. Every 512 chips (odd number of 256 chips), the pilot symbols from the Odd Pilot Processing block (pilotOT512, pilotOT512Prev) are used to compute for the phase difference, and the phase difference from the two antennas are combined together.

At the initialization, the FTL 135 starts with Acquisition Mode. The switching from Acquisition Mode to Tracking Mode is implemented by setting a counter (freqAcqModeCount) to a specific value at the initialization and then the counter counting down each time the FTL is updated (every 512 chips). When the counter equals zero, the FTL enters Tracking Mode. The transition from Acquisition Mode to Tracking Mode also applies to the Time Track Loop 140, as the TTL 140 and the FTL 135 share the same counter.

During a compressed mode gap, the state variables are frozen (skip operation.) At the end of the gap, the state (freqErrAccum) is kept as-is or reset to 0 depending on a flag (flag shared between all fingers.) In acquisition mode, at the first 256 chip boundary, the pilotOT256 is updated but the frequency discriminator is not run since the pilotOT256prev will be the old value (prior to the gap). At the second 256 chip boundary, the FTL 135 is run. In tracking mode, at the first 512 chip boundary, the pilotOT512 is updated but the frequency discriminator is not run since the pilotOT512prev will be the old value (prior to the gap). At the second 512 chip boundary, the FTL 135 is run.

In the FTL 135, different FTL gain values are used in acquisition and tracking modes. As stated above, the acquisition/tracking mode switch, crossMode, is shared between the frequency tracking loop (FTL) 135 and Time Tracking loop (TTL) 140, and is maintained by the FTL 135. Thus, the FTL 135 and TTL 140 are either both in acquisition mode or both in tracking mode. The FTL 135 generates the freqErrAccum and crossMode (Acquisition/Tracking) for the TTL 140.

The FTL 135 is skipped when pn_cnt_{—}256_chips=0 per frame in the acquisition mode. In acquisition mode, pilotOT256 and pilotOT256prev are used in the frequency discriminator, and these symbols are not paired (only) when pn_cnt_256_chips==0. In tracking mode, pilotOT512 and pilotOT512prev are used so this problem does not exist. The FTL 135 is updated in even finger processing periods (pn_cnt_{—}256_chips=even number, but not zero) in the Acquisition Mode, and in odd finger processing periods (pn_cnt_256_chips=odd number) in the Tracking Mode. The FTL operation is regardless of the finger lock status.

To gain the benefits of coherent demodulation, the receiver must depsread each down link channel with a PN sequence that is phase-locked to the down link common pilot channel. The Time Tracking Loop (TTL) 140 performs this phase synchronization by selecting the optimum sampling phase so that the common pilot channel is depreaded with maximum SNR. Since the optimum sampling point can change due to code doppler and TCXO drift, the Time Tracking Loop 140 tracks the changes and adjusts the finger sampling phase by issuing advance and retard commands.

The Time Tracking Loop uses a Delayed Locked Loop (DLL), that takes the difference of the early pilot sample energy (½ chip early than the ontime pilot symbol) and the late pilot sample energy (1/2 chip later than the ontime pilot symbol):

TTerror=∥early pilot symbol in 256 chips∥²−∥late pilot symbol in 256 chips∥²

The TTerror is low pass filtered using an IIR filter of the form:

y(n)=y(n−1)+Gain*x(n)

The result is then accumulated with the scaled frequency error (freqerrAccum from the FTL) to account for the errors in the frequency estimate. A spectral inversion sign is applied on the scaled freqerrAccum before it is summed with the IIR filter output. The spectral inversion sign (+1 or −1) indicates if the baseband signal is spectrally inverted, depending on the phone RF design. This is shown in FIG. 18.

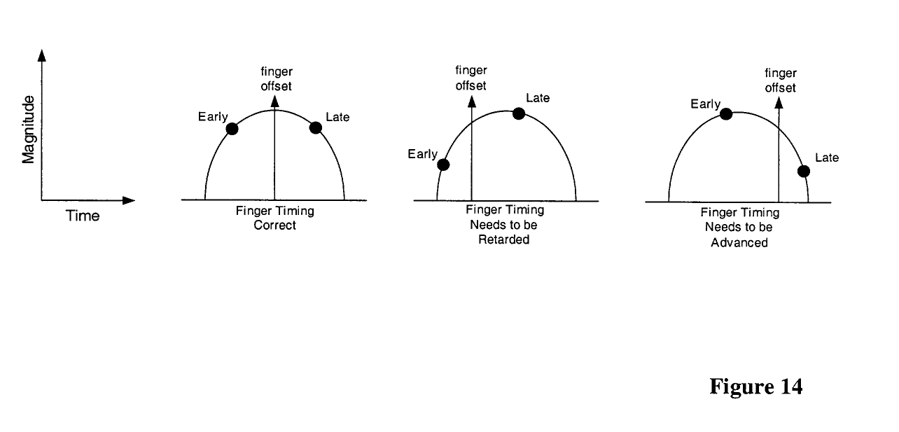

If the accumulator (TTAccum) overflows a specified threshold (chipx8TTLAccum), an advance command is issued to the finger to advance the finger PN position by one chipx8 cycle, and the TTAccum is decremented by chipx8TTLAccum. If the accumulator (TTAccum) underflows a specified threshold (−chipx8TTLAccum<<15), a retard command is issued to the finger to retard the finger PN position by one chipx8 cycle, and the TTAccum increments by chipx8TTLAccum. FIG. 14 presents a visual representation of the early and late energies for the three offset cases.

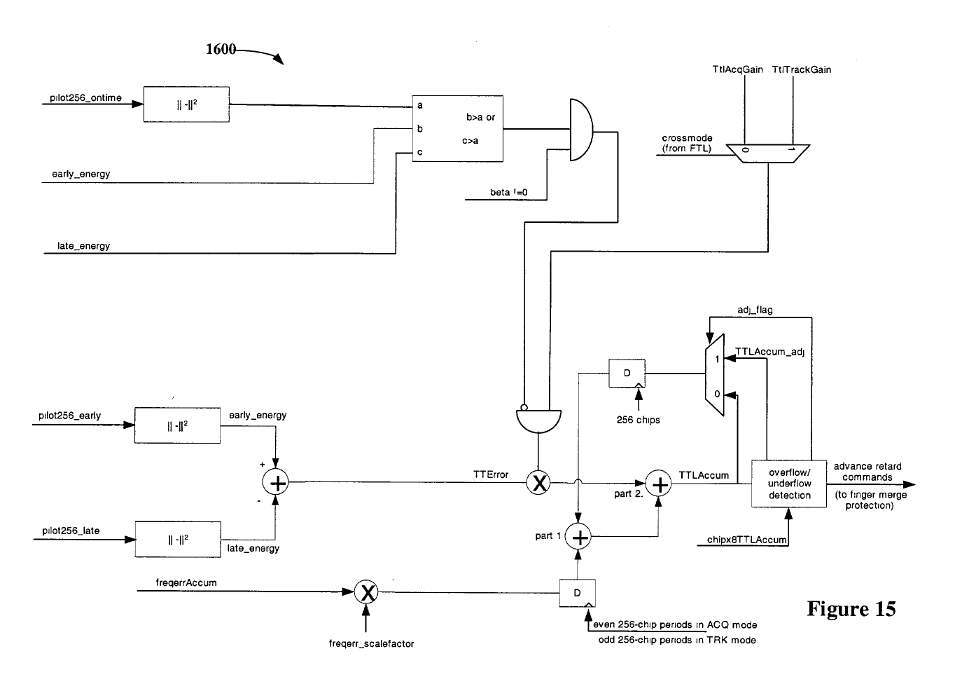

FIG. 15 shows the architecture 1600 of the TTL 140. The algorithm for the overflow/underflow detection is as follows, (chipx8TTLAccum=13333 for 2 GHz):

if (TTAccum > (chipx8TTLAccum<<15)

TTAccum_adj = TTAccum − (chipx8TTLAccum << 16);
advance command = 1; (advance by a chipx8 cycle);
retard command = 0; (no retard);
adj_Aag = 1;

else if (TTAccum <− (chipx8TTLAccum<<15))

TTAccum_adj = TTAccum + (chipx8TTLAccum<<16);
advance command = 0; (no advance);
retard command = 1; (retard by a chipx8 cycle);
adj_flag = 1;

else

TTAccum_adj = 0;
advance command = 0; (no advance);
retard command = 0; (no retard);
adj_flag =0;

The time discriminator of the TTL 1800 may be modified. The modified discriminator introduces a smaller pull-in range (when beta is non zero value) that is beneficial under under fat path conditions, and also does not hurt us under single-path conditions. The algorithm of the modified time discriminator is as flowing:

TTError = early_energy − late_energy;
if ( Round(early_energy, n) > ontime) ∥ Round(late_energy, n) >
ontime) )

{

td = 0;

}

where n = {3, 2, 1, 0} for beta = {1, 2, 4, 8}
If beta = 0, the time discriminator becomes the same as the current design.

The new timing discriminator greatly reduces the need for a centralized external merge protection, thus resulting in reduced complexity. It can also lead to improved performance over externally-imposed merge protection since the various fingers can track their “true” timing, that is not always the case if the fingers are prevented from moving.

Also, this new discriminator can be used in combination with external finger-monitoring to enhance performance even further, in that case the frequency of external finger-monitoring is reduced compared to when the new timing discriminator is not used.

During a compressed mode gap, TTAccum keeps being updated every 256-chip period. The TTError (equals to TTLGain*(Early pilotEnergy−Late pilotEnergy) in FIG. 18) in the TTL is forced to be ‘0’, only the scaled freqerrAccum (from FFL) is accumulated when the TTAccum is updated. At the end of the compressed mode gap, State (TTAccum) is kept as-is or reset to 0 depending on a flag (flag shared between all fingers.)

When the finger is out of the Time Tracking (TT) lock, the TTError (equals to TTLGain*(Early pilotEnergy−Late pilotEnergy) in FIG. 18) in the TTL is forced to be ‘0’, so only the scaled freqerrAccum (from FTL) is accumulated when the TTAccum is updated. The ttAccum value is incremented by TTError only if the TT lock status (from the RSSI lock detect algorithm) is “true”.

The TTL 140 should use different TTL gain values in acquisition and tracking modes. The acquisition/tracking mode switch, crossMode, is shared between the frequency tracking loop (FTL) 135 and TTL 140, and is maintained by the FTL 135. Thus, the FTL 135 and TTL 140 are either both in acquisition mode or both in tracking mode. The TTL 140 operates in the every finger processing period.

The DSP processor indicates the start and stop of compressed mode through a flag called cmFingerDisableFlag. This flag takes effect at the following 256-chip boundary, and is common to all 12 fingers. (That is, when the flag is set, each finger will go into compressed mode at it's succeeding 256-chip boundary.) At the end of the compressed mode gap, the flag is reset to 0, and all fingers will be re-enabled at the following 256-chip boundary.

The finger operation during the compressed mode gap is as follows:

The pnCount generation proceeds to keep getting the pn_count_256 strobes, that is used to re-enable the finger operation at the end of the gap.

The DSP processor interrupts (for every active finger) is still generated even though no symbols are generated.

The phaseAcc is updated (every chip) to keep track of the frequency/phase error.

The despreading, decovering, accumulation and DDE operation may be suspended during the compressed mode gap.

During the compressed mode gap, the Nt_Io Estimate, RSSI Lock Detect, FTL, TTL, and Pilot Filter should be “frozen”, or the operations should be skipped. The TTL just keeps accumulating the scaled frequency error from FTL.

At the end of the compressed mode gap, the hardware may provide the option of either re-using the saved state variable, or resetting the state variable to a specific value (maybe 0.) A flag is provided for each state variable and a location to store the value to load at the end of the gap. The end of the compressed mode gap is indicated by the cmFingerDisableFlag being reset to 0, and takes effect at the following 256-chip boundary.

At the end of the compressed mode gap, the value pilotOT256prev and pilotOT512prev may be out-of-date. Thus, the NtIoEstimate and FTL may be suspended for another 512 chips for these values to be updated before running these two blocks. The other three loops (RSSILockDetect, TTL and pilotFilter) depend only on the pilotOT256 or on the pilotIIRState so can be restarted immediately at the end of the gap. For simplicity, all five blocks may be suspended for an additional 512 chips following the compressed mode gap.

Although the present device has been fully described in connection with the preferred embodiments thereof with reference to the accompanying drawings, it is to be noted that various changes and modifications will become apparent to those skilled in the art. Such changes and modifications are to be understood as being included within the scope of the present device as defined by the appended claims.

What is claimed is:

1. A wireless communication device including a pilot processor for processing a pilot signal, the pilot processor being an integrated hardware component comprised of a pilot filter, an odd pilot processor, a received signal strength indicator (RSSI) lock detection unit, a Nt_Io estimator, a frequency tracking loop, and a time tracking loop.

2. The wireless communication device of claim 1, wherein the pilot filter provides an estimation of channel fading coefficients.

3. The wireless communication device of claim 1, wherein the odd pilot processor separates received pilot sequences.

4. The wireless communication device of claim 1, wherein the received signal strength indicator (RSSI) lock detection unit produces a received signal strength indication.

5. The wireless communication device of claim 1, wherein the Nt_Io estimator computes the energy of an interference signal and the pilot signal.

6. The wireless communication device of claim 1, wherein the frequency tracking loop corrects a frequency error of the pilot signal.

7. The wireless communication device of claim 1, wherein the time tracking loop selects the optimum sampling phase so the pilot signal is despread with maximum signal to noise ratio.

8. The wireless communication device of claim 1, wherein the pilot processor comprises combinations of a Multiple and Accumulation (MAC), an adder and subtractor (ADD_SUB), and an IIR filter.

9. The wireless communication device of claim 1, wherein the pilot processor further comprises pipeline registers, DSP process registers, and parameter RAM.

10. An integrated device comprising:
a pilot filter responsive to a pilot signal for providing an estimation of channel fading coefficients;
an odd pilot processor responsive to the pilot signal for separating received pilot sequences;
a received signal strength indicator (RSSI) lock detection unit responsive to the pilot filter for producing a received signal strength indication;
an Nt_Io estimator responsive to the pilot signal for computing the energy of an interference signal and the pilot signal;
a frequency tracking loop responsive to the pilot signal for correcting a frequency error of the pilot signal; and
a time tracking loop responsive to the pilot signal for selecting an optimum sampling phase so the pilot signal is despread with maximum signal to noise ratio.

11. The device of claim 10, wherein the pilot filter, the odd pilot processor, the received signal strength indicator (RSSI) lock detection unit, the Nt_Io estimator, the frequency tracking loop, and the time tracking loop are implemented using combinations of a Multiple and Accumulation (MAC), an adder and subtractor (ADD_SUB), and an IIR filter.

12. The device of claim 11, further comprising the MAC, a plurality of ADD_SUB, and a plurality of IIR filters.

13. The device of claim 12, wherein the plurality of ADD_SUB is used by the pilot filter, the odd pilot processor, and the Nt_Io estimator.

14. The device of claim 12, wherein the MAC is used by the received signal strength indicator (RSSI) lock detection unit, the Nt_Io estimator, the frequency tracking loop, and the time tracking loop.

15. The device of claim 12, wherein the plurality of IIR filters is used by the pilot filter, the received signal strength indicator (RSSI) lock detection unit, the Nt_Io estimator, the frequency tracking loop, and the time tracking loop.

16. The device of claim 11, further comprising pipeline registers, DSP processor registers, and parameter RAM.

17. An integrated hardware device for processing a pilot channel comprising:
a Multiple and Accumulation (MAC) block which calculates energy and cross product;
a plurality of adder and subtractors (ADD_SUBs) which adds or subtracts between input data;
a plurality of IIR filters which function as low pass filters;
pipeline and DSP processor configuration registers; and
parameter RAM which stores the results of the last processing cycle.

18. The device of claim 17, wherein the plurality of ADD_SUBs are used to generate a pilot filter, an odd pilot processor, and an Nt_Io estimator.

19. The device of claim 17, wherein the MAC block is used to generate a received signal strength indicator (RSSI) lock detection unit, the Nt_Io estimator, a frequency tracking loop, and a time tracking loop.

20. The device of claim 17, wherein the plurality of IIR filters is used to generate the pilot filter, the received signal strength indicator (RSSI) lock detection unit, the Nt_Io estimator, the frequency tracking loop, and the time tracking loop.
